(19) United States
(12) Patent Application Publication
(10) Pub. No.: US 2015/0293818 A1
(43) Pub. Date: Oct. 15, 2015

(54) METHOD OF PROTECTED RECOVERY OF DATA, COMPUTER PROGRAM PRODUCT AND COMPUTER SYSTEM

(71) Applicant: FUJITSU TECHNOLOGY SOLUTIONS INTELLECTUAL PROPERTY GMBH, München (DE)

(72) Inventor: Heinz-Josef Claes, Nidderau (DE)

(21) Appl. No.: 14/439,003

(22) PCT Filed: Oct. 31, 2013
(86) PCT No.: PCT/EP2013/072799

§ 371 Date: Apr. 28, 2015

(30) Foreign Application Priority Data
Nov. 2, 2012 (DE) 10 2012 110 507.3

(51) Int. Cl. G06F 11/14

(52) U.S. Cl. CPC G06F 11/1469; G06F 2201/85

(57) ABSTRACT

A method of protected recovery of data stored in a backup computer system on a source computer system, wherein an access controller is provided that queries access information of a user group to access a recovery process, but prohibits access of the user group to the data stored in the backup computer system and prohibits general access of the user group to the source computer system per se, subject to write access if necessary to rewrite data onto the source computer system. The recovery process can be instigated by a user of the user group if the queried access information matches stored access information of the user group, wherein the instigated recovery process comprises a rewriting of selected data from the backup computer system into the source computer system.

### TECHNICAL FIELD

This disclosure relates to a method of protected recovery of data which are stored in a backup computer system, on a source computer system. The disclosure furthermore relates to a computer program product containing a computer program that carries out a method of this type when run on a computer system. In addition, the disclosure relates to a computer system that carries out a method of this type.

### BACKGROUND

System support operatives or administrators have facilities to access the hardware or rights to access the software of a computer system to maintain and administer the computer system so that a fault-free operation of the computer system or a fault-free use of the computer system by an end user is guaranteed. The problem here is that the extended access rights of system support operatives or administrators generally also enable access to personal and confidential data stored on the operated computer system. Administrators therefore have the facility, for example, to read confidential data.

Conventional methods of ensuring the confidentiality of data or data protection in general are provided by defining, for example, contractually, specific regulations (processes which are to be followed) and rules (prescriptions and prohibitions) between the individual user groups of a computer system. However, the problem with those methods is that user groups with extended access rights, for example, employees of a software service provider, may be criminal, blackmailed or bribed. Technical measures are thus required which prevent access to confidential data within a computer system.

In particular, system data or user data stored in a backup computer system may be subject to unauthorized access by system support operatives or administrators. If, for example, system support operatives or administrators run a recovery process to recover the aforementioned data on an original source computer system, they generally have access to data of this type. The aim is therefore to prevent system data from being modified or manipulated by a system support operative or administrator, or to prevent confidential user data from being read.

Technical measures entailing encryption of data of this type allow only limited or circumventable access protection since the data can be decrypted or reconstructed by knowledgeable users or are present in unencrypted form through suitable measures during processing (for example, in the processor core of the backup computer system) or during their backup in the source computer system. Measures entailing an encryption of the data are consequently not sufficient on their own to ensure increased data protection.

It could therefore be helpful to provide a method, a computer program product and a computer system which, through technical measures, enable protected recovery of data stored in a backup computer system, on a source computer system, and to prevent prohibited access to these data.

### SUMMARY

I provide a method of protected recovery of data stored in a backup computer system on a source computer system including providing an access controller that queries access information of a user group to access a recovery process, but prohibits access of the user group to the data stored in the backup computer system and prohibits general access of the user group to the source computer system, subject to write access if necessary to rewrite the data onto the source computer system, wherein the recovery process is instigated by a user of the user group if the queried access information matches stored access information of the user group, and the instigated recovery process includes rewriting selected data from the backup computer system into the source computer system.

I also provide a computer program product containing a computer program which carries out the method of protected recovery of data stored in a backup computer system on a source computer system including providing an access controller that queries access information of a user group to access a recovery process, but prohibits access of the user group to the data stored in the backup computer system and prohibits general access of the user group to the source computer system, subject to write access if necessary to rewrite the data onto the source computer system, wherein the recovery process is instigated by a user of the user group if the queried access information matches stored access information of the user group, and the instigated recovery process includes rewriting selected data from the backup computer system into the source computer system when run on a computer system.

I further provide a computer system including an access control unit that controls access to a recovery process for the recovery of data in the computer system or in a different computer system, wherein the access control unit carries out the method of protected recovery of data stored in a backup computer system on a source computer system including providing an access controller that queries access information of a user group to access a recovery process, but prohibits access of the user group to the data stored in the backup computer system and prohibits general access of the user group to the source computer system, subject to write access if necessary to rewrite the data onto the source computer system, wherein the recovery process is instigated by a user of the user group if the queried access information matches stored access information of the user group, and the instigated recovery process includes rewriting selected data from the backup computer system into the source computer system.

### BRIEF DESCRIPTION OF THE DRAWINGS

FIG. 1 shows a schematic representation of a computer network infrastructure that implements my method.

FIG. 2 shows a schematic representation of a computer network infrastructure for an alternative implementation of my method.

### REFERENCE NUMBER LIST

1 Backup computer system
2 Access control unit
2B Access control unit in the source computer system
31 Backup memory
3A, 3B, 3C Memory in the source computer system
4 Administrator computer system
5 Communication interfaces
6 Administrator tool
A, B, C Source computer system
D_A, D_B, D_C Backup data of the source computer systems
Recover Command to instigate a recovery process

### DETAILED DESCRIPTION

I provide an access controller that queries access information of a user group to access a recovery process, but prohibits access of the user group to the data or data content (e.g., in the backup and/or source computer system). The recovery process can be instigated by a user of the user group if the queried access information matches stored access information of the user group, wherein the instigated recovery process comprises a rewriting of selected data from the backup computer system into the source computer system.

A method of this type allows a user of the user group only to access a recovery process to recover data from the backup computer system into a source computer system. However, access to the data both in the backup computer system and in the source computer system and also during their processing in an ongoing rewrite or recovery process (e.g., by the access controller) is prohibited for the user of the user group by the access control unit. This means that a user, in the event of successful authorization via the access controller through the querying of stored access information, can only carry out, instigate or trigger the recovery process. A rewriting of selected data from the backup computer system into the source computer system can be carried out in an automated manner. The access controller represents a security hurdle so that the data cannot be accessed, but only their recovery on a source computer system can be triggered.

The advantage of this method lies in that system support operatives or administrators cannot modify or manipulate, let alone open and read, any relevant data. However, system support operatives and administrators can perform their system support tasks by triggering or carrying out a targeted recovery of data on a source computer system (from which these data originate) so that, for example, a backup of the computer system can be reloaded there and a specific fault condition can be corrected.

The data in the backup computer system may be any data of a system, for example, user data, configuration data, hard disk image data and the like.

The term “source computer system” covers any type of computer system that can store data of the above type via a backup process in the backup computer system by a computer network. Thus, data stored in the backup computer system originate from at least one computer system of this type as their source. It is also possible for the source computer system and the backup computer system to be configured as a complete system. In this case, backup data are stored within this complete system via a backup process in a backup memory and can be recovered from the latter.

The term “access to data” in this context covers any read and/or write access to data or data content. The term “data” can be understood here as information (raw data in unencrypted form). A write access (write rights) to the source and/or backup computer system per se may be allowed by the access controller to rewrite data from the backup computer system onto the source computer system.

The recovery process advantageously restricts a rewrite of the data to a predetermined source computer system. This has the advantage that the data cannot be rewritten onto any given computer system which, in some instances, may not represent the actual source computer system of the data. In this way, a system support operative or administrator can be prevented from loading the data onto a computer system which is not authorized for these data. In particular, it is possible to prevent a system support operative or administrator from transferring confidential data of a first user from the backup computer system onto a computer system of a second user not authorized to access the confidential data of the first user.

An instigated recovery process thus advantageously triggers only a rewrite of the data onto the source computer system from which the data actually originate. The data to be rewritten may, for example, contain specific information on the source computer system (e.g., IP or MAC address or path information and the like) which uniquely characterizes a predetermined source computer system. However, so-called “hard links” (I-nodes) can be configured and allocated to arrange an archiving (backup) or rewrite (recovery) of data or files (including their attributes and metadata).

The method may, for example, be carried out by an access controller in a computer system implemented as system software or within a microcontroller module as a logical sequential program or as a combination of both. The access controller can be integrated as an access control unit in a complete system (combined source and backup computer system). However, it is also possible for the access controller to comprise at least a software agent or a plurality of sub-programs or software agents or microcontrollers configured on a plurality of computer systems within a computer network infrastructure to enable recovery of the data from one computer system as the backup computer system into another computer system as the source computer system. The access controller can also be configured on a computer system specifically configured for this purpose along with a backup computer system and a source computer system. It is possible that the access controller grants a user a write access to the source computer system to rewrite the data, but prohibits a read and/or write access to the data both in the source computer system and in the backup computer system.

Preferably, the access controller provides a graphical user interface to query the access information and/or instigate the recovery process and/or select the data for the recovery process.

One possible application of the method advantageously occurs within a secured or protected computer network infrastructure, referred to as a “sealed infrastructure.” A backup computer system (alternatively or additionally thereto also source computer systems) can generally be encapsulated in an infrastructure of this type such that access to specific or all data or data content in a computer system of this type (i.e., logical access to the computer system) and/or mechanical access to the hardware of the computer system (i.e., physical access) is not possible or is possible to a restricted extent only. Systems of this type can be configured so that only predetermined data and information can be forwarded from the system unidirectionally outwards within a network infrastructure. In particular, the retention of data within the backup computer system, which hitherto entailed the risk of unauthorized access to the data, can be improved in this way by the explained method since the access to predetermined information in the backup computer system is allowed to a restricted extent only or is prohibited for users of the user group.

During the rewrite from the backup computer system into the source computer system, the data are preferably written automatically to a predetermined memory address or a predetermined memory location (this may also be a specific address space) in the source computer system. This has the advantage for a user of the source computer system that, following a successfully run recovery process, the original data are present at a predetermined location, e.g., at the original location once more, in the data system of the source computer system. A user of the source computer system can thus quickly locate the data. It is also possible to reconstruct all links and paths of recovered files in a simple manner such that the user of the source computer system can continue to work without great adaptation difficulties.

The access controller advantageously prohibits access of the user group whose users can instigate the recovery process in the backup computer system to data or data content in the source computer system or general access to the source computer system per se (if necessary subject to write access to rewrite data onto the source computer system). This generally means that users of the user group who can instigate a recovery of data from the backup computer system into the source computer system are not to be allocated to the user group of users who simultaneously have unrestricted access to the source computer system. For example, the user group that can instigate the recovery process in the backup computer system can be formed by system support operatives or administrators. However, the latter are prohibited from accessing data or data content in the source computer system. Only a user group of end users of the source computer system has unrestricted access to data or data content of the source computer system.

However, it is possible that, along with the user group that can instigate the recovery process in the backup computer system, but has no access to the data in the backup computer system, a further user group exists which can similarly instigate the recovery process in the backup computer system, but, unlike the first user group, also has access to selected data in the backup computer system. The access controller can advantageously additionally query access information of the at least one further user group to access the recovery process and can permit access of the at least one further user group to selected data in the backup computer system. As already explained, the recovery process can be instigated by a user of the at least one further user group if the queried access information matches stored access information of the at least one further user group. A recovery process can thus be instigated by the last-mentioned user if, similar to the first user group already explained, the user has successfully self-authenticated or authorized on the backup computer system. Preferably, the access controller permits access of the at least one further user group to data in the source computer system. For example, it is possible that end users of a source computer system personally have access to data in the backup computer system, i.e., can read these data and simultaneously have them rewritten from the backup computer system into their source computer system to perform a data recovery.

The access controller advantageously allows files in which the data are summarized in the backup computer system or which represent the data in the backup computer system to be deleted or renamed, but not opened. This aspect applies in particular to the first user group which can only instigate a recovery process in the backup computer system, but itself has no access to the data. For this user group, it may furthermore be permitted, according to a different aspect, to rename or delete files in the source computer system also. Both aforementioned aspects have the advantage that data which recognizably no longer have to or can be recovered or which represent outdated information can be deleted, for example, by a system support operative or administrator. Files can also be renamed in the source computer system, for example, to prevent files from being overwritten during the rewrite from the backup computer system onto the source computer system. This increases flexibility in the rewrite. Due to the facility to delete or rename files, a manipulation of data is possible, but this has no negative impact on increased data protection since the information to be protected can nevertheless not be accessed.

Preferably, the data are encrypted by the access controller.

Generally, it is also possible to display file names, in particular of the first user group, in encrypted form only or, alternatively, converted into a hash value. This is appropriate, for example, if predetermined file packets are to be recovered whose file names may already contain private or confidential information. However, this is appropriate only if a recovery of a file packet is to be instigated without specific files having to be selected on the basis of their file name. It is possible, for example, for an end user to convert personal files or entire directories via a predetermined hash algorithm (e.g., MD5) into a hash value and transfer them in this form to a user who can only instigate a recovery process (e.g., administrator). The latter sees hash values only, instead of the actual combination of file path and file name. Selection and, if necessary, recovery of these files or directories can then be carried out via the access control unit using the hash values without confidential information being visible within the file paths or file names. Alternatively or additionally hereto, implementation of a four-eyes principle would also be possible, wherein processing of file names can be carried out by an administrator only if it has been released or verified in advance by a corresponding user.

Preferably, the queried access information comprises at least a username and a password.

I also provide a computer program product and a computer system. The computer program product contains a computer program that carries out a method when run on a computer system.

The computer system has an access control unit to control access to a recovery process to recover data in the computer system or in a different computer system, wherein the access control unit carries out the method.

My methods, computer program product and computer system are explained in detail below with reference to the drawings.

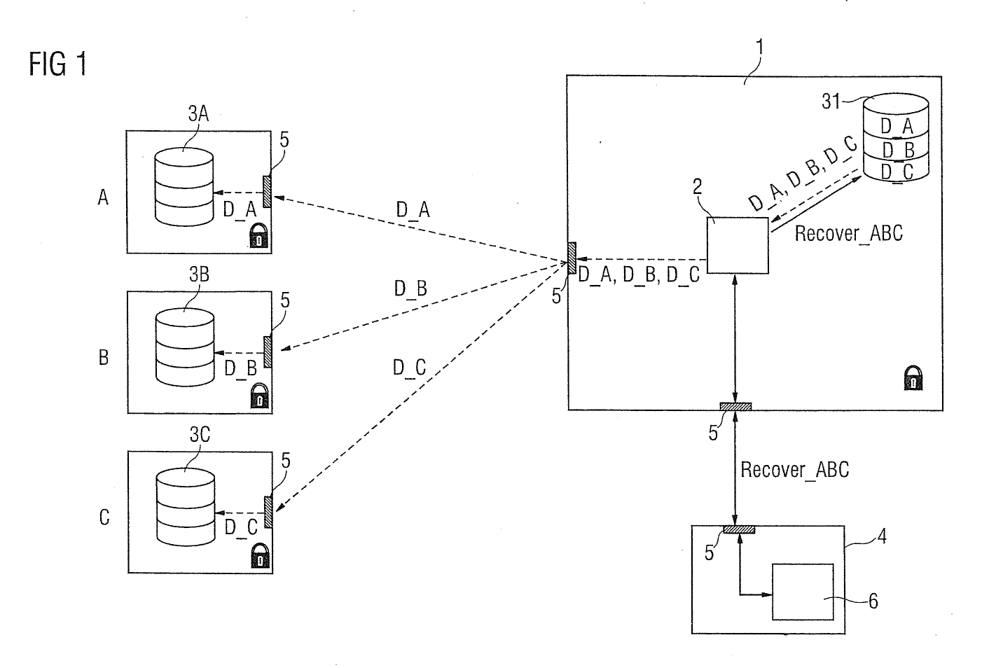

FIG. 1 shows a schematic representation of a computer network infrastructure comprising a plurality of computer systems. In particular, FIG. 1 shows a backup computer system 1, an administrator computer system 4 and a plurality of source computer systems A, B and C. This configuration is merely an example, wherein the computer network infrastructure may also comprise further computer systems, in particular further source computer systems, or may have a different configuration.

The backup computer system 1 forms the central system of the infrastructure. The backup computer system 1 may, for example, comprise a data server of a service provider, wherein an access control unit 2 is configured in the backup computer system 1, the tasks of which are explained in detail below.

In addition, the backup computer system 1 comprises a backup memory 31 in which backup data D_A, D_B, D_C of individual source computers A, B, C are stored. The backup data D_A, D_B, D_C have been transferred, for example, during a backup process from individual source computer systems A, B, C to the backup computer system 1 and have been stored in the backup memory 31 by the access control unit 2. However, for the sake of simplicity, this process is not shown in FIG. 1. In FIG. 1, it is assumed that backup data D_A, D_B, D_C are retained in any form in the backup memory 31 for recovery of these data on at least one of the source computer systems A, B, C.

The backup computer system 1 is designed according to the configuration in FIG. 1 as a protected or encapsulated system (indicated by a lock symbol). The backup computer system 1 may, for example, form part of a so-called “sealed infrastructure.” This means that access of users within the complete system (for example, by the administrator computer system 4 or one of the source computer systems A, B, C) from outside to the protected backup computer system 1, in particular to backup data D_A, D_B, D_C in the backup memory 31, is not possible. Thus, for example, access to the backup memory 31 from outside may be generally prohibited. Only a restricted access to a functionality of the access control unit 2 of the backup computer system 1 is permitted.

It is alternatively or additionally also possible that only the access control unit 2 forms part of the encapsulated system (only the access control unit 2 would then be denoted by a lock symbol). The backup memory 31 may be configured outside the encapsulated system, in particular outside the backup computer system 1. In this case, all backup data D_A, D_B, D_C are advantageously present in encrypted form in the backup memory 31 so that access to the backup data D_A, D_B, D_C as such (i.e., to information to be protected) is not possible, despite access to the backup memory 31 (e.g., for a recovery, replication and the like). An encryption can be effected by the access control unit 2.

A recovery process of backup data D_A, D_B, D_C from the backup memory 31 to one of the source computer systems A, B, C can be performed according to FIG. 1 as follows. An authentication of an authorized user of the administrator computer system 4 can first be performed on the access control unit 2 in the backup computer system 1 via an administrator tool 6 in the administrator computer system 4. To do this, a user enters, for example, a username and/or a user password, generally predetermined access information, via the administrator tool 6 in the administrator computer system 4. The administrator tool 6 may be any form of a man-machine interface.

The access information is transmitted via communication interfaces 5 to the access control unit 2 and compared within the access control unit 2 with previously stored access information so that a positive authentication of a user of the administrator computer system 4 is permitted if the entered access information matches access information stored in the access control unit 2. Otherwise, the access control unit 2 denies access to components of the backup computer system 1 by the administrator computer system 4.

If necessary, the access control unit 2 can also transmit information or commands to the administrator tool 6 in the administrator computer system 4 (see two-way connection between the backup computer system 1 and the administrator computer system 4). Thus, for example, in the event of an unsuccessful authentication of a user, an error message or warning can be output to the administrator computer system 4.

To communicate with the administrator computer system 4, the access control unit 2 and/or the administrator tool 6 may, for example, provide a graphical user interface via which a user of the administrator computer system 4 can perform inputs or settings or queries.

Following successful authentication of the administrator computer system 4 on the access control unit 2, a command to instigate a recovery process Recover can be issued by a user of the administrator computer system 4 (i.e., by a system support operative or administrator). FIG. 1 shows an example of a command to instigate a recovery process Recover_ABC for the recovery of backup data D_A, D_B, D_C from the backup memory 31 to the individual source computer systems A, B, C. To do this, the command Recover_ABC is transmitted to the access control unit 2 in the backup computer system 1, wherein, in the event of positive authentication in the access control unit 2, a recovery process is triggered.

This recovery process causes access of the access control unit 2 to the backup memory 31 in the backup computer system 1, wherein backup data D_A, D_B, D_C are transferred from the backup memory 31 to the access control unit 2. The backup data D_A, D_B, D_C may, for example, be present in encrypted form in the backup memory 31 and may be decrypted for further processing within the access control unit 2. However, access to the decrypted backup data D_A, D_B, D_C is prohibited by the access control unit 2.

The backup data D_A, D_B, D_C are then transmitted via interfaces 5 to the individual source computer systems A, B, C in the computer network infrastructure. This advantageously takes place following further encryption within the access control unit 2. In detail, the data D_A are transmitted to the source computer system A, the data D_B are transmitted to the source computer system B, and the data D_C are transmitted to the source computer system C. This means that each source computer system obtains the backup data predetermined for this system. The individual source computer systems A, B, C are similarly advantageously encapsulated systems (see in each case lock symbol). It is possible that the systems A, B, C, along with the system 1 or, alternatively, along with the access control unit 2 only, form subsystems of a protected complete system or form autonomous encapsulated systems. It is thus prohibited for unauthorized users to access data D_A, D_B, D_C (particularly in unencrypted form) in the respective systems A, B, C. Only write access to the systems A, B, C can be permitted to enable a recovery of backup data D_A, D_B, D_C on the systems A, B, C.

The backup data D_A, D_B, D_C may contain stored information (e.g., IP or MAC address, path information, I-nodes and the like) relating to the destination to which the data are to be transmitted accordingly. This information may be interpreted in the access controller 2, wherein the backup data D_A, D_B, D_C are then distributed accordingly.

Alternatively to the configuration shown in FIG. 1, it is also possible to provide an additional control component in the backup computer system 1 to rewrite the data from the backup memory 31 to the individual source computer systems A, B, C. An additional component of this type has the advantage that the backup data D_A, D_B, D_C are not transferred to the access control unit 2 itself, but to the additional component. As a result, a user of the administrator computer system 4 can be prevented from obtaining access directly to the backup data D_A, D_B, D_C through manipulations.

In the respective source computer systems A, B, C, the respectively rewritten data D_A, D_B, D_C can be stored in corresponding memories 3A, 3B, 3C. In this way, it is possible, for example, to rewrite system, configuration or user data from the backup computer system 1 into the original source computer systems A, B, C. It is possible for the memories 3A, 3B, 3C, to be configured alternatively to the configuration shown in FIG. 1 in each case outside the systems A, B, C. In this case, data D_A, D_B, D_C are present in the memories 3A, 3B, 3C in encrypted form only (i.e., protected against unauthorized access to confidential information). A corresponding encryption can be carried out by the access control unit 2 or by components within the systems A, B, C.

It is advantageous if the recovery process restricts a rewrite of the respective data exclusively to the original source computer system. This means, for example, that the backup data D_A can be rewritten exclusively to the source computer system A. A correspondingly differing instruction may, for example, be aborted or entirely prohibited by the access control unit 2. In this way, confidential data intended to be accessible to users of a specific source computer system only are prevented from being transferred to a different source computer system.

A decisive factor in the configuration according to FIG. 1 is that a user of the administrator computer system 4 can instigate a recovery process Recover_ABC only if the user has self-authenticated successfully on the access control unit 2. However, access to the backup data D_A, D_B, D_C is prohibited for the administrator computer system 4. Furthermore, no facility exists to access the source computer systems A, B, C via the administrator computer system 4.

In this way, a system support operative or administrator only has the facility to dispatch a command to the backup computer system 1 if required, wherein an automated routine then runs to rewrite backup data D_A, D_B, D_C from the backup computer system 1 to the original source computer system A, B, C.

According to the configuration in FIG. 1, access to backup data D_A, D_B, D_C in the backup memory 31 of the backup computer system 1 is not permitted for any of the computer systems A, B, C and 4. However, the individual source computer systems A, B, C receive corresponding backup data D_A, D_B, D_C if the recovery process Recover_ABC has been initiated.

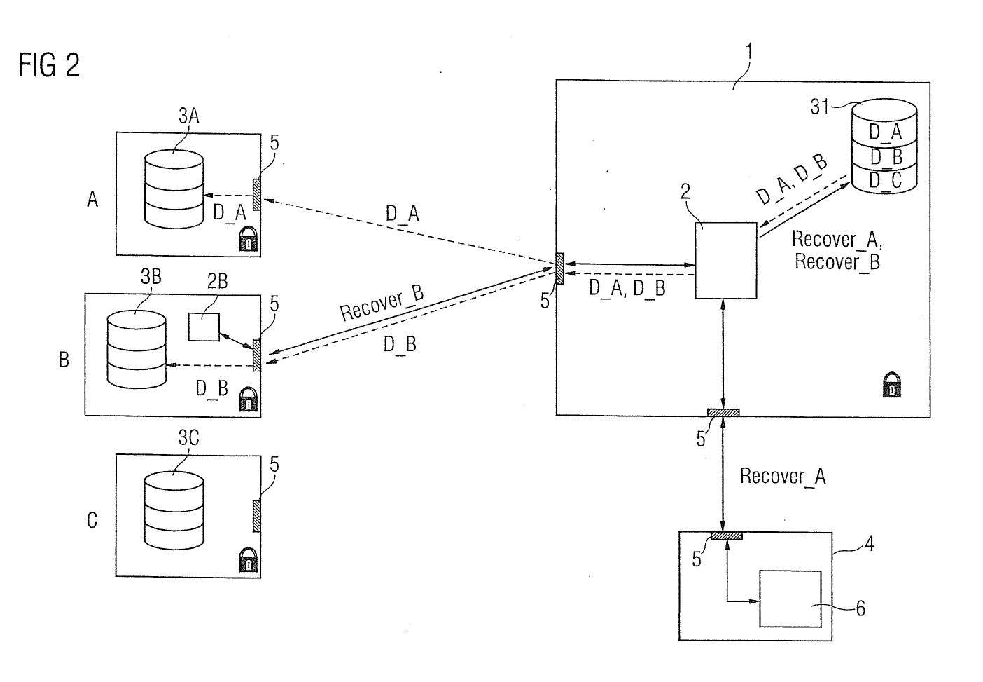

A changed situation is shown in FIG. 2. The individual components of the computer network infrastructure are essentially structured in the same way as in FIG. 1 (the alternative configurations mentioned in connection with FIG. 1 are of course also possible), but with the difference that now, for example, the source computer system B also has a facility to access the access control unit 2 of the backup computer system 1.

For this purpose, the source computer system B comprises an access control unit 2B which can communicate and interact with the access control unit 2 in the backup computer system 1. In this way, it is possible for the user of the source computer system B to authenticate himself via the access control unit 2B of the source computer system B on the access control unit 2 of the backup computer system 1. A corresponding process can run as already explained in connection with FIG. 1. In the event of successful authentication of a user of the source computer system B on the backup computer system 1, a command Recover_B, for example, can be instigated for the targeted recovery of backup data D_B. The command is transmitted to the access control unit 2, wherein, similar to the procedure according to FIG. 1, a recovery process is triggered in the access control unit 2. The recovery process effects a loading of backup data D_B from the backup memory 31. The backup data D_B can then be transmitted by the communication interfaces 5 to the source computer system B and can be stored in the latter, for example, in the memory 3B, as shown in FIG. 2.

A user of the system B may be an end user with unrestricted access rights to the system B and also to data D_B in the system B. However, it is also possible that the user is, e.g., an administrator who has access to the system B, in particular to restricted functionalities of the access control unit 2B for a recovery process Recover_B, but is prohibited from accessing data D_B.

It is also possible that an end user of the source computer system B simultaneously has direct access to the backup data D_B in the backup memory 31 of the backup computer system 1. This can be effected, for example, by configuring access rights to the backup data D_B according to the access rights in the source computer system B. This alternative can have the advantage for a user of the source computer system B of editing, viewing, selecting and the like backup data D_B directly in the backup computer system 1.

However, access to the backup memory 31 in the backup computer system 1 depends on the security level and configuration of the encapsulated backup computer system 1. The highest security level obviously exists if access of this type to the backup memory 31 is prohibited or is simply not possible. A user of the source computer system B can then only instigate a recovery process Recover_B in the access control unit 2 so that the corresponding backup data D_B are rewritten to the source computer system B.

Similar to the procedure according to FIG. 1, an administrator of the administrator computer system 4 can, in parallel with the explained procedure, instigate a different command Recover_A for the recovery of backup data D_A from the backup memory 31 of the backup computer system 1 onto the source computer system A. This procedure is similar to the procedure already described according to FIG. 1. A corresponding recovery process Recover_A effects a loading of the backup data D_A and a transmission of these data to the source computer system A, wherein the data D_A may, for example, be stored in the memory 3A. A decisive factor in this configuration according to FIG. 2 also is that the user group of the administrator computer system 4 has no access to the backup data D_A, D_B, D_C in the backup memory 31 of the backup computer system 1.

The source computer system C has no direct involvement in the situation according to FIG. 2. Also in the example according to FIG. 2, it is possible, along with the access control unit 2, to provide a further component via which backup data D_A, D_B, D_C are loaded from the backup memory 31 for a recovery.

Communication with the access control unit 2 can be effected in all the examples shown, for example, via a graphical user interface, for example, browser-based. This has the advantage that a user wishing to instigate a recovery process Recover can, for example, have specific folders (not their content) displayed to select data for the recovery process without being able to view these data. The authentication also and, if necessary, additional setting options on the access control unit 2 can easily be carried out via a graphical user interface.

The access control unit 2 may be designed, for example, as a computer program which runs in a computing component of the backup computer system 1. The same may apply to the access control unit 2B and to the administrator tool 6 of the administrator computer system 4.

Furthermore, any transfer of backup data D_A, D_B, D_C may be carried out in all designs in encrypted form to increase access protection against unauthorized access to the backup data D_A, D_B, D_C outside the backup computer system 1 or outside the systems A, B, C also. Those skilled in the art can make use of all possible cryptographic techniques or encryption algorithms.

The configurations shown are chosen merely as examples, wherein various alternative designs are possible which are similarly covered by the method, computer program product and computer system.

1-13. (canceled)

14. A method of protected recovery of data stored in a backup computer system on a source computer system comprising providing an access controller that queries access information of a user group to access a recovery process, but prohibits access of the user group to the data stored in the backup computer system and prohibits general access of the user group to the source computer system, subject to write access if necessary to rewrite the data onto the source computer system,
wherein the recovery process is instigated by a user of the user group if the queried access information matches stored access information of the user group, and the instigated recovery process comprises rewriting selected data from the backup computer system into the source computer system.

15. The method according to claim 14, wherein the recovery process restricts a rewrite of the data to a predetermined source computer system.

16. The method according to claim 15, wherein, during the rewrite from the backup computer system into the source computer system, the data are automatically written to a predetermined memory address in the source computer system.

17. The method according to claim 14, wherein the access controller additionally queries access information of at least one further user group to access the recovery process and permits access of the at least one further user group to selected data in the backup computer system, wherein the recovery process can be instigated by a user of the at least one further user group if the queried access information matches stored access information of the at least one further user group.

18. The method according to claim 15, wherein the access controller (2, 2B, 6) additionally queries access information of at least one further user group to access the recovery process and permits access of the at least one further user group to selected data in the backup computer system, and the recovery process is instigated by a user of the at least one further user group if the queried access information matches stored access information of the at least one further user group.

19. The method according to claim 16, wherein the access controller (2, 2B, 6) additionally queries access information of at least one further user group to access the recovery process and permits access of the at least one further user group to selected data in the backup computer system, and the recovery process can be instigated by a user of the at least one further user group if the queried access information matches stored access information of the at least one further user group.

20. The method according to claim 14, wherein the access controller allows files in which the data are summarized in the backup computer system to be deleted or renamed, but not opened.

21. The method according to claim 15, wherein the access controller allows files in which the data are summarized in the backup computer system to be deleted or renamed, but not opened.

22. The method according to claim 16, wherein the access controller allows files in which the data are summarized in the backup computer system to be deleted or renamed, but not opened.

23. A computer program product containing a computer program which carries out the method according to claim 14 when run on a computer system.

24. A computer program product containing a computer program which carries out the method according to claim 22 when run on a computer system.

25. A computer system comprising an access control unit that controls access to a recovery process for the recovery of data in the computer system or in a different computer system, wherein the access control unit carries out the method according to claim 14.

26. A computer system comprising an access control unit that controls access to a recovery process for the recovery of data in the computer system or in a different computer system, wherein the access control unit carries out the method according to claim 22.
